(19) United States
(12) Patent Application Publication
(10) Pub. No.: US 2025/0210797 A1
(43) Pub. Date: Jun. 26, 2025

(54) SECONDARY BATTERY

(71) Applicant: MURATA MANUFACTURING CO., LTD., Nagaokakyo-shi (JP)

(72) Inventor: Kunio SODEYAMA, Nagaokakyo-shi (JP)

(21) Appl. No.: 18/924,262

(22) Filed: Oct. 23, 2024

(30) Foreign Application Priority Data
Dec. 21, 2023 (JP) 2023-215375

(51) Int. Cl. H01M 50/342

(52) U.S. Cl. CPC H01M 50/3425; H01M 2200/20

(57) ABSTRACT

A secondary battery is provided and includes a battery element; a housing member that houses the battery element; and a safety valve attached to the housing member, in which the safety valve includes at least a configuration in which a safety cover including a protrusion at a center, a disk holder including an opening at a center, a stripper disk including a cavity at a center, and a sub disk that joins to the protrusion extending through the opening of the disk holder and the cavity of the stripper disk are combined in this order from relatively on an outer side to an inner side of the housing member, and the stripper disk includes a recess on a surface located on the relatively inner side of the housing member, and the recess houses the sub disk.

### CROSS REFERENCE TO RELATED APPLICATIONS

The present application claims priority to Japanese patent application no. 2023-215375, filed on Dec. 21, 2023, the entire contents of which is incorporated herein by reference.

### BACKGROUND

The present disclosure relates to a secondary battery. The present disclosure particularly relates to a secondary battery including an electrode assembly including a positive electrode, a negative electrode, and a separator.

Secondary batteries are capable of extracting energy due to chemical change or the like as electric energy. Secondary batteries are so-called storage batteries and therefore can be repeatedly charged and discharged. Secondary batteries are used in various applications. For example, the batteries are used in mobile devices such as mobile phones, smart phones, and notebook computers.

Conventionally, such a secondary battery is disclosed, for example, including a battery element including a positive electrode, a negative electrode, and an electrolytic solution, a housing member that houses the battery element, and a safety valve mechanism attached to the housing member. The safety valve mechanism includes a valve member having an opening valve portion that can open. The safety valve mechanism cuts off the current at the time of abnormality and suppresses further generation of gas in the battery. This can suppress an increase in the internal pressure of the battery and can avoid breakage of the housing member.

### SUMMARY

The present disclosure relates to a secondary battery. More specifically, the present disclosure relates to a secondary battery including an electrode assembly including a positive electrode, a negative electrode, and a separator.

There is still room for development of a function of the battery, for example, in which the safety valve mechanism is operated at the time of abnormality to avoid danger such as breakage of the housing member, but the safety valve is not operated in normal times.

The present disclosure, in an embodiment, relates to providing a secondary battery having further improved vibration resistance.

A secondary battery according to an embodiment of the present disclosure is provided.

The secondary battery including: a battery element; a housing member that houses the battery element; and a safety valve attached to the housing member, in which
the safety valve includes at least a configuration in which a safety cover including a protrusion at a center, a disk holder including an opening at a center, a stripper disk including a cavity at a center, and a sub disk that joins to the protrusion extending through the opening of the disk holder and the cavity of the stripper disk are combined in this order from relatively on an outer side to an inner side of the housing member, and
the stripper disk includes a recess on a surface located on the relatively inner side of the housing member, and the recess houses the sub disk.

The battery according to an embodiment of the present disclosure can provide a secondary battery having further improved vibration resistance.

### BRIEF DESCRIPTION OF THE FIGURES

FIG. 1 is a schematic perspective view illustrating an appearance of a secondary battery according to an embodiment of the present disclosure;

FIG. 2 is a schematic view illustrating an internal configuration of the secondary battery according to an embodiment of the present disclosure;

FIG. 3 is a schematic perspective view illustrating constituent members and related members of a safety valve of the secondary battery according to an embodiment of the present disclosure in a developed state;

FIG. 4 is an exploded schematic perspective view illustrating the constituent members of the safety valve of the secondary battery according to an embodiment of the present disclosure cut in a half in a developed state;

FIG. 5 is a schematic perspective view illustrating the safety valve of the secondary battery according to an embodiment of the present disclosure cut in a half;

FIG. 6 is a schematic sectional view of the safety valve of the secondary battery according to an embodiment of the present disclosure;

FIG. 7 is a schematic view illustrating a suitable combination state of the members in the safety valve;

FIG. 8 is a schematic perspective view illustrating an exemplary mode in which a conductive member and a sub disk are welded to each other;

FIG. 9 is a schematic sectional view of a safety valve of a conventional secondary battery;

FIG. 10 is a schematic sectional view illustrating a state of an operated safety valve;

FIG. 11 is a schematic sectional view illustrating a state of the safety valve that is further operated (from the state illustrated in FIG. 10);

FIG. 12 is a plan view illustrating a safety cover of the secondary battery according to an embodiment of the present disclosure; and

FIG. 13 is a plan view illustrating a safety cover of a secondary battery according to another embodiment of the present disclosure.

### DETAILED DESCRIPTION

The present disclosure will be described below in further detail according to an embodiment. It should be noted that the following description and examples for those skilled in the art to fully understand the present disclosure, and these are not intended to limit the claimed subject matter. That is, the present disclosure is not particularly limited to the preferred embodiments and the like described below, and can be appropriately modified. Note that, in consideration of the description of the main points or ease of understanding, the present disclosure may be explained by being divided into embodiments, examples, and the like, for convenience, but partial replacement and/or combination of configurations illustrated in different embodiments and the like are possible. In the description of such an embodiment, redundant description of substantially the same matters may be omitted, and only different points may be described. In particular, similar functions and effects made by similar configurations are sometimes not be sequentially mentioned for each embodiment.

Further, in the description in the present specification, reference to a direction, an orientation, or the like is merely for convenience of description, and is not intended to limit the scope of the present disclosure unless otherwise explicitly described. For example, relative terms such as “outer (or outer side, outer part, or outer peripheral)” and “Inner (or inner side, inner part, or inner peripheral)” and derived terms thereof should be understood to refer to directions described or illustrated. Similarly, “on” an element includes not only a case of being in contact with the upper surface of the element but also a case of not being in contact with the upper surface of the element. That is, “on” an element includes not only an upper position away from the element, that is, an upper position via another object on the element or an upper position spaced apart from the element, but also an immediately above position in contact with the element. In addition, “on” does not necessarily mean the upper side in the vertical direction. “On” merely indicates a relative positional relationship of certain elements. That is, unless otherwise explicitly described, the invention is not limited only to a specific direction, orientation, form, or the like. In addition, the same applies to terms such as “provided”, “arranged”, and “connected”, and derived terms thereof. Unless otherwise explicitly described, the terms are not limited to a direct mode, and may be a mode in which another element such as an intervening object is interposed.

The various numerical ranges mentioned in the present specification are intended to include the lower and upper limit numerical values themselves unless otherwise specified, for example, by “less than”. For example, it is interpreted that a numerical range such as 0.35 to 0.45 mm includes the lower limit value 0.35 mm and the upper limit value 0.45 mm.

“Secondary battery” as used in the present specification can be repeatedly charged and discharged. The “secondary battery” is not excessively limited by its name, and for example, “power storage devices” and the like can also be included in the subject.

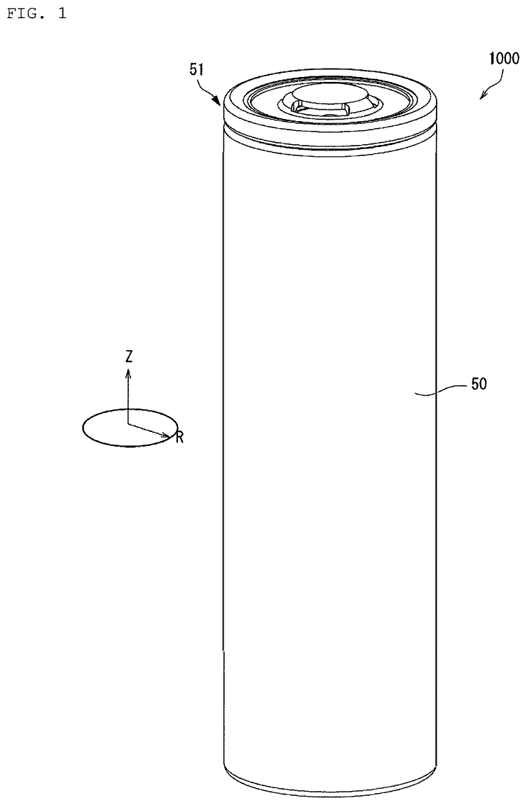

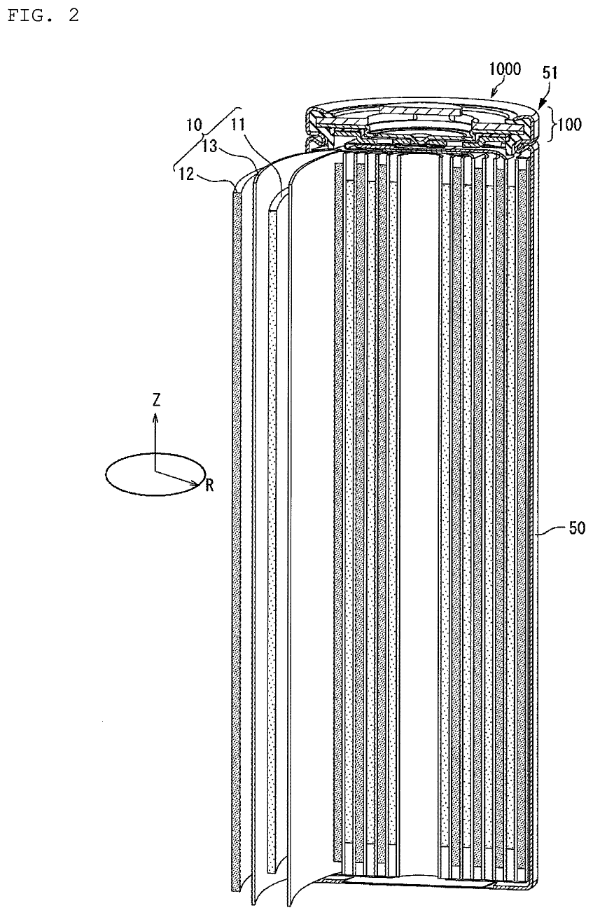

A secondary battery according to an embodiment as a basic configuration of the present disclosure will be described with reference to FIGS. 1 and 2. FIG. 1 is a schematic perspective view illustrating an appearance of a secondary battery according to the present embodiment. FIG. 2 is a schematic view illustrating the internal configuration of the secondary battery of the present embodiment. In FIGS. 1 to 2, the Z axis is parallel to the battery axis. In the present specification, the battery axis corresponds to the central axis of a cylindrical exterior body. The forward Z direction refers to a direction parallel to the battery axis and vertically upward in the present specification. The reverse Z direction refers to a direction parallel to the battery axis and vertically downward in the present specification. In vertical directions (Z directions), the forward Z direction is relatively referred to as an upper side, and the reverse Z direction is relatively referred to as a lower side. An R direction is a direction (radial direction) orthogonal to the Z direction and away from the battery axis in plan view.

In the present specification, a cylinder means that a cylinder shape has a large ratio (aspect ratio) of the height to the equivalent circle diameter of the bottom surface (for example, an aspect ratio of 1 or more). Here, the equivalent circle diameter of a bottom surface refers to the diameter of a circle having an area equal to the area of the bottom surface.

As illustrated in FIGS. 1 and 2, a secondary battery 1000 according to the present embodiment includes an electrode assembly (battery element) 10, a battery can (exterior body, housing member) 50 that houses the battery element 10, and a safety valve 100 attached to the battery can 50. In the secondary battery 1000, such an electrode assembly 10 is sealed (housed) in the exterior body 50 together with an electrolyte (for example, a non-aqueous electrolyte). The electrode assembly 10 includes a positive electrode 11, a negative electrode 12, and a separator 13 disposed between the positive electrode 11 and the negative electrode 12. In the secondary battery 1000 according to the present embodiment, the electrode assembly 10 may have a wound structure (hereinafter, also referred to as “wound electrode body” or “wound structure”) in which the separator 13 is wound in a roll shape in a state of being disposed between the positive electrode 11 and the negative electrode 12.

The secondary battery 1000 may be a cylindrical secondary battery (for example, a cylindrical non-aqueous secondary battery). In other words, the secondary battery 1000 may include a cylindrical case, that is, a cylindrical battery can 50. The safety valve 100 may be provided at a cylindrical end portion of the secondary battery 1000 (in particular, an open end 51 side of the battery can 50).

The positive electrode 11 includes at least a positive electrode material layer and a positive electrode current collector. In the positive electrode 11, the positive electrode material layer is provided on at least one surface of the positive electrode current collector. The positive electrode material layer contains a positive electrode active material as an electrode active material. For example, for each of a plurality of positive electrodes 11 in the electrode assembly 10, the positive electrode material layer may be provided on both surfaces of the positive electrode current collector, or may be provided only on one surface of the positive electrode current collector.

The negative electrode 12 includes at least a negative electrode material layer and a negative electrode current collector. In the negative electrode 12, the negative electrode material layer is provided on at least one surface of the negative electrode current collector. The negative electrode material layer contains a negative electrode active material as an electrode active material. For example, for each of a plurality of negative electrodes 12 in the electrode assembly 10, the negative electrode material layer may be provided on both surfaces of the negative electrode current collector, or may be provided only on one surface of the negative electrode current collector.

The electrode active materials contained in the positive electrode 11 and the negative electrode 12, that is, the positive electrode active material and the negative electrode active material are materials directly involved in transfer of electrons in the secondary battery 1000, and are main materials of the positive electrode 11 and negative electrode 12 that are responsible for charge and discharge, that is, the battery reaction. More specifically, ions are brought into the electrolyte due to the “positive electrode active material contained in the positive electrode material layer” and the “negative electrode active material contained in the negative electrode material layer”, and the ions move between the positive electrode 11 and the negative electrode 12 to transfer electrons, and thus charge and discharge is performed. The positive electrode material layer and the negative electrode material layer may be layers particularly capable of occluding and releasing lithium ions. That is, the secondary battery 1000 of the present embodiment may be a non-aqueous electrolyte secondary battery, in which lithium ions move between the positive electrode 11 and the negative electrode 12 through the non-aqueous electrolyte to charge and discharge the second battery 1000. When lithium ions are involved in charge and discharge, the secondary battery 1000 of the present embodiment corresponds to a so-called “lithium ion battery”, and includes layers capable of occluding and releasing lithium ions as the positive electrode 11 and the negative electrode 12.

When the secondary battery 1000 according to the present embodiment is a lithium ion battery, the positive electrode active material may be a material that contributes to occlusion and release of lithium ions. That is, the positive electrode layer may contain any one or two or more among positive electrode materials capable of occluding and releasing lithium. From such a viewpoint, the positive electrode active material may be, for example, a lithium-containing compound. The lithium-containing compound is not particularly limited in its type, but may be, for example, a lithium-containing composite oxide, a lithium-containing phosphate compound, or the like. This is because a high energy density can be easily obtained.

The lithium-containing composite oxide is a generic name of oxides containing lithium and one or two or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one or two or more of other elements as constituent elements, and may have, for example, a crystal structure such as an olivine crystal structure. The type of the other elements is not particularly limited as long as the element is any one or two or more of any elements. Among them, as the other elements, one or two or more of elements belonging to Groups 2 to 15 in the long-period periodic table is preferable. More specific examples of the other elements includes nickel (Ni), cobalt (Co), manganese (Mn) and iron (Fe). This is because a high voltage is likely to be obtained by these additive elements.

Examples of the lithium-containing composite oxide having a layered rock-salt type crystal structure include compounds each represented by the following Formulas (1) to (3).

LiₐMn_{(1-b-c)}Ni_{b}M11_{c}O_{(2-d)}Fe (1)

(In Formula (1), M11 is at least one of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); “a” to “e” satisfy 0.8≤a≤1.2, 0<b<0.5, 0≤c≤0.5, (b+c)<1, −0.1≤d≤0.2, and 0≤e≤0.1. However, the composition of lithium varies depending on the charged and discharged states, and “a” is a value of a fully discharged state.)

LiₐNi_{(1-b)}M12_{b}O_{(2-c)}F_{d} (2)

(In Formula (2), M12 is at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.8≤a≤1.2, 0.005≤b≤0.5, −0.1≤c≤0.2, and 0≤d≤0.1. However, the composition of lithium varies depending on the charged and discharged states, and “a” is a value of a fully discharged state.)

LiₐCo_{(1-b)}M13_{b}O_{(2-c)}F_{d} (3)

(In Formula (3), M13 is at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.8≤a≤1.2, 0≤b<0.5, −0.1≤c≤0.2, and 0≤d≤0.1. However, the composition of lithium varies depending on the charged and discharged states, and “a” is a value of a fully discharged state.)

Specific examples of the lithium-containing composite oxide having a layered rock-salt type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15} (Mn_{0.65}Ni_{0.22}Co_{0.13})O₂.

When the lithium-containing composite oxide having a layered rock-salt crystal structure contains nickel, cobalt, manganese, and aluminum as constituent elements, the atomic ratio of nickel is preferably 50 atomic % or more. This is because a high energy density can be easily obtained.

Examples of the lithium-containing composite oxide having a spinel type crystal structure include a compound represented by the following Formula (4).

LiₐMn_{(2-b)}M14_{b}O_{c}F_{d} (4)

(In Formula (4), M14 is at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.9≤a≤1.1, 0≤b≤0.6, 3.7≤c≤4.1, and 0≤d≤0.1. However, the composition of lithium varies depending on the charged and discharged states, and “a” is a value of a fully discharged state.)

Specific examples of the lithium-containing composite oxide having a spinel type crystal structure include LiMn₂O₄.

Examples of the lithium-containing phosphate compound having an olivine type crystal structure include a compound represented by the following Formula (5).

LiₐM15PO₄ (5)

(In Formula (5), M15 is at least one of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); “a” satisfies 0.9≤a≤1.1. However, the composition of lithium varies depending on the charged and discharged states, and “a” is a value of a fully discharged state.)

Specific examples of the lithium-containing phosphate compound having an olivine type crystal structure include LiFePO₄, LiMnPO₄, LiFe_{0.5}Mn_{0.5}PO₄, and LiFe_{0.3}Mn_{0.7}PO₄.

The lithium-containing composite oxide may be a compound represented by the following Formula (6).

(Li₂MnO₃)ₓ(LiMnO₂)₁₋ₓ (6)

(In Formula (6), x satisfies 0≤x≤1. However, the composition of lithium varies depending on the charged and discharged states, and “x” is a value of a fully discharged state.)

In addition, for example, the positive electrode material may be any one or two or more among oxides, disulfides, chalcogenides, and conductive polymers. Examples of the oxide include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and may be a material other than the above materials.

The positive electrode material layer may contain a binder. A positive electrode conductive agent may also be contained in the positive electrode material layer to facilitate transmission of electrons promoting the battery reaction. The binder of the positive electrode 11 may contain, for example, any one or two or more synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent includes, for example, any one or two or more of carbon materials. The carbon material may be, for example, graphite, carbon black, acetylene black, ketjen black, or the like. However, the positive electrode conductive agent may be a metal material, a conductive polymer, and the like, as long as it is a material exhibiting conductivity.

Similarly, the negative electrode active material of the negative electrode material layer may be a material that contributes to occlusion and release of lithium ions. That is, the negative electrode layer may contain any one or two or more among negative electrode materials capable of occluding and releasing lithium. From such a viewpoint, the negative electrode active material may be, for example, various carbon materials, metal-based materials, and/or other materials.

When the carbon material is used as the negative electrode active material, the crystal structure shows a very small change when lithium is occluded and released, so that a high energy density can be easily and stably obtained. Further, the carbon material also functions as a negative electrode conductive agent, and thus the negative electrode layer easily has an improved conductivity.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at an appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic term for materials containing any one or two or more among metal elements and metalloid elements as constituent elements. When a carbon material is used as the negative electrode active material, a high energy density is likely to be obtained. The metal-based material may be a single metal, an alloy, a compound, two or more of these, or may be a material at least a part of which has phases composed of one of, or two or more of these. However, the alloy may include a material containing one or more metal elements and one or more metalloid elements in addition to a material composed of two or more of metal elements. The alloy may also contain a non-metallic element. The construction of this metal-based material may be, for example, a solid solution, a eutectic (eutectic mixture), an intermetallic compound, and a material in which two or more among these coexist. Such metal element and metalloid element may be, for example, any one of, or two or more of metal elements and metalloid elements capable of forming an alloy with lithium. Specific examples of the metal element and the metalloid element may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium, yttrium (Y), palladium (Pd), and/or platinum (Pt). In a preferred aspect, the metal elements are silicon and tin. This is because these metal elements have excellent ability to occlude and release lithium, and a higher energy density is likely to be obtained. A material containing silicon as a constituent element may be a simple substance of silicon, an alloy of silicon, or a compound of silicon, may be two or more selected from these materials, or may be a material at least a part of which has phases composed of one of, or two or more of these. Similarly, the material containing tin as a constituent element may be a simple substance of tin, an alloy of tin, or a compound of tin, may be two or more thereof, or may be a material at least a part of which has one or two or more of these phases. The “simple substance” described here is a simple substance in a general sense to the utmost, and thus the simple substance may contain a small amount of impurities. That is, the purity of the single substance is not necessarily limited to 100%. The alloy of silicon contains, for example, any one or two or more of tin, nickel, copper, iron, cobalt, manganese, zinc, indium, silver, titanium, germanium, bismuth, antimony, chromium, and the like as constituent elements other than silicon. The compound of silicon contains, for example, any one or two or more of carbon, oxygen, and the like as constituent elements other than silicon. The compound of silicon may contain, for example, any one or two or more of a series of elements described in the alloy of silicon as constituent elements other than silicon. Specific examples of the alloy of silicon and the compound of silicon include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiO_{V} (0<v≤2), and/or LiSiO. In SiOᵥ, “v” may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more of carbon, oxygen, and the like, as constituent elements other than tin. The compound of tin may contain any one or two or more of a series of elements described in the alloy of tin, for example, as constituent elements other than tin. Specific examples of the alloy of tin and the compound of tin include SnO, (0<w≤2), SnSiO₃, LiSnO, and/or Mg₂Sn. In particular, the material containing tin as a constituent element may be, for example, a material containing a second constituent element and a third constituent element together with tin, which is a first constituent element (tin-containing material). The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one of, or two or more of boron, carbon, aluminum, phosphorus, or the like. This is because high battery capacity and excellent cycle characteristics are likely to be obtained by these elements. In particular, the tin-containing material may be a material (tin cobalt carbon-containing material) containing tin, cobalt, and carbon as constituent elements. This is because a high energy density is likely to be obtained by these materials. In the tin cobalt carbon-containing material, at least part of carbon which is a constituent element may be bonded to a metal element or metalloid element which is another constituent element. This is because the aggregation of tin, crystallization of tin, and the like are likely to be suppressed. Such a tin-cobalt-carbon-containing material is not limited to the material (SnCoC) that contains only tin, cobalt, and carbon as constituent elements. This tin cobalt carbon-containing material may further contain, for example, any one or two or more of silicon, iron, nickel, chromium, indium, niobium, germanium, titanium, molybdenum, aluminum, phosphorus, gallium, bismuth, and the like as a constituent element in addition to tin, cobalt, and carbon. In addition to the tin cobalt carbon-containing material, a material containing tin, cobalt, iron, and carbon as constituent elements (tin cobalt iron carbon-containing material) may be included.

In addition, the negative electrode material may be any one or two or more among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Furthermore, a negative electrode conductive agent may be included in the negative electrode material layer to facilitate the transfer of electrons promoting the battery reaction. The binder that may be contained in the negative electrode material layer is not particularly limited, but examples thereof include at least one selected from the group consisting of styrene-butadiene rubber, polyacrylic acid, polyvinylidene fluoride, polyimide-based resin, and polyamideimide-based resin. The negative electrode conductive agent that may be contained in the negative electrode material layer is not particularly limited, and examples of the negative electrode conductive agent may include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like. Note that the negative electrode material layer may contain a component derived from a thickener component (for example, a carboxymethyl cellulose) used during battery production.

The positive electrode current collector and the negative electrode current collector used in the positive electrode 11 and the negative electrode 12 are members that contribute to collecting and supplying electrons generated in the electrode active material due to the battery reaction. Such an electrode current collector may be a sheet-shaped metal member. The electrode current collector may have a single layer or multiple layers. Further, the electrode current collector may have a porous or perforated form. For example, the current collector may be a metal foil, a punching metal, a net, an expanded metal, or the like. The positive electrode current collector used for the positive electrode 11 may include, for example, a metal foil containing at least one selected from the group consisting of aluminum, nickel, stainless steel, and the like. On the other hand, the negative electrode current collector used for the negative electrode 12 may include, for example, a metal foil containing at least one selected from the group consisting of copper, aluminum, nickel, stainless steel, and the like.

The separator 13 used in the positive electrode 11 and the negative electrode 12 is a member provided from the viewpoint of, for example, preventing a short circuit due to contact between the positive electrode 11 and the negative electrode 12, and holding the electrolyte. In other words, the separator 13 is a member that isolates the positive electrode 11 and the negative electrode 12 from each other, and allows ions (for example, lithium ions) to pass therethrough while preventing a short circuit of current due to contact between both electrodes. For example, the separator 13 may be a porous or microporous insulating member, which may have a membrane form due to its small thickness.

The separator 13 may be, for example, any one or two or more of porous membranes such as synthetic resin and/or ceramic, and may be a laminated membrane of two or more porous membranes. The synthetic resin used for the separator 13 is, for example, polytetrafluoroethylene, polypropylene, polyethylene, and the like. For example, the separator 13 may include, a porous film (substrate layer) and a polymer compound layer provided on one side or both sides of the substrate layer. This improves the close contact of the separator to the positive electrode and may improve the close contact of the separator to the negative electrode, and thus the distortion of the wound electrode body is likely to be suppressed. The polymer compound layer may contain, for example, any one of, or two or more of polymer compounds such as polyvinylidene fluoride. This makes it easy to have excellent physical strength and to be electrochemically stable. The polymer compound layer may contain any one of, or two or more of insulation grains such as an inorganic grain. Examples of the type of inorganic grain include aluminum oxide and aluminum nitride. In the present disclosure, the separator is not to be particularly limited by its name, and it may be solid electrolytes, gel electrolytes, and/or insulating inorganic grains that have a similar function.

In the secondary battery 1000 according to the present embodiment, the electrode assembly 10 including the positive electrode 11, the negative electrode 12, and the separator 13 may be sealed in the exterior body 50 together with the electrolyte. The electrolyte may be a so-called “non-aqueous” electrolyte.

The electrolyte (typically, an electrolytic solution) contains a solvent and an electrolyte salt. The electrolytic solution may further contain any one or two or more of other materials such as additives. In a preferred embodiment, the separator 13 may be impregnated with the electrolytic solution, and the positive electrode 11 and/or the negative electrode 12 may also be impregnated with the electrolytic solution.

The solvent may contain any one or two or more of non-aqueous solvents such as organic solvents. The electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile). This makes it easy to obtain further improved battery capacity, cycle characteristics, and/or storage characteristics. Examples of the cyclic carbonate ester may include ethylene carbonate, propylene carbonate, and/or butylene carbonate. Examples of the chain carbonate ester include dimethyl carbonate, diethyl carbonate, ethyl methyl carbonate, and/or methyl propyl carbonate. Examples of the lactone include γ-butyrolactone and/or γ-valerolactone. Examples of the chain carboxylate ester include methyl acetate, ethyl acetate, methyl propionate, ethyl propionate, methyl butyrate, methyl isobutyrate, methyl trimethylacetate, and/or ethyl trimethylacetate. Examples of the nitrile include acetonitrile, methoxyacetonitrile, and/or 3-methoxypropionitrile. Examples of the non-aqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. In particular, the non-aqueous solvent preferably contains one or two or more of ethylene carbonate, propylene carbonate, dimethyl carbonate, diethyl carbonate, ethyl methyl carbonate, and the like. This is because higher battery capacity, further improved cycle characteristics, and/or more excellent storage characteristics can be easily obtained. Further, examples of the non-aqueous solvent may include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This makes it easy to improve the chemical stability of the electrolytic solution. The “unsaturated cyclic carbonate ester” described herein is a cyclic carbonate ester having one or two or more unsaturated bonds (carbon-carbon double bonds or carbon-carbon triple bonds). Examples of the unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. When the halogenated carbonate ester contains two or more halogens as a constituent element, the type of the two or more halogens may be one type or two or more types. Examples of the cyclic halogenated carbonate esters include 4-fluoro-1,3-dioxolan-2-one and/or 4,5-difluoro-1,3-dioxolan-2-one. Examples of the chain halogenated carbonate esters include fluoromethyl methyl carbonate, bis(fluoromethyl) carbonate, and/or difluoromethyl methyl carbonate. Examples of the sulfonate ester include a monosulfonate ester and/or a disulfonate ester. The monosulfonate ester may be a cyclic monosulfonate ester or a chain monosulfonate ester. Examples of the cyclic monosulfonate ester include sultones such as 1,3-propane sultone and/or 1,3-propene sultone. Examples of the chain monosulfonate ester include a compound in which a cyclic monosulfonate ester is cleaved in the middle. The disulfonate ester may be a cyclic disulfonate ester or a chain disulfonate ester. Examples of the acid anhydride include carboxylic anhydrides, disulfonic anhydrides, and/or carboxylic sulfonic anhydrides. Examples of the carboxylic anhydride include succinic anhydride, glutaric anhydride, and/or maleic anhydride. Examples of the disulfonic anhydride include ethanedisulfonic anhydride and/or propanedisulfonic anhydride. Examples of the carboxylic sulfonic anhydrides include anhydrous sulfobenzoic acid, anhydrous sulfopropionic acid, and/or anhydrous sulfobutyric acid. Examples of the dinitrile compound include a compound represented by NC—R1-CN (R1 is an alkylene group or an arylene group). Examples of the dinitrile compound include succinonitrile (NC—C₂H₄—CN), glutaronitrile (NC—C₃H₆—CN), adiponitrile (NC—C₄H₃—CN), and phthalonitrile (NC—C₆H₄—CN). Examples of the diisocyanate compound include a compound represented by OCN—R2-NCO (R2 is an alkylene group or an arylene group). Examples of the diisocyanate compound include hexamethylene diisocyanate (OCN—C₆H₁₂—NCO). Examples of the phosphate ester include trimethyl phosphate and triethyl phosphate. The chain compound having a carbon-carbon triple bond is a chain compound having one or two or more carbon-carbon triple bonds (—C≡C—). Examples of the chain compound having a carbon-carbon triple bond include propargyl methyl carbonate (CH≡C—CH₂—O—C(═O)—O—CH₃) and propargyl methyl sulfonate (CH≡C—CH₂—O—S(═O)₂—CH₃).

For example, the electrolyte salt included in the electrolytic solution may include any one or two or more of salts such as a lithium salt. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because further improved battery capacity, cycle characteristics, and/or storage characteristics can be easily obtained. Among them, one or two or more of lithium hexafluorophosphate, lithium tetrafluoroborate, lithium perchlorate, and lithium hexafluoroarsenate may be used.

The exterior body 50 used for the secondary battery 1000 corresponds to a member that houses the electrode assembly 10 including the positive electrode 11, the negative electrode 12, and the separator 13 as a battery exterior body (housing member). Such an exterior body 50 may also be referred to as, for example, a “battery can”. The exterior body 50 may have, for example, a hollow structure in which one end portion is closed and a cavity is provided at the other end portion. The cavity may be a through hole formed in one end portion of the exterior body. The structure of the exterior body including such a cavity can also be understood as a structure including an open end whose one end is released. The open end 51 of the exterior body 50 is provided with the safety valve 100.

The electrode assembly 10 may have a conductive member as a terminal. The conductive member is electrically connected to one of the positive electrode and the negative electrode in the electrode assembly 10, and contributes to electrical connection between the electrode assembly 10 and the safety valve 100. The electrode assembly 10 such as the wound structure is electrically connected to the battery external terminal with the conductive member interposed therebetween. In the present specification, the conductive member may be a member containing metal, and preferably may be a metal member having an elongated shape. For example, the conductive member may be formed of an electrode current collector of the electrode assembly 10 or may be a current collecting lead (that is, a lead) provided in the electrode assembly (in particular, the electrode). When the conductive member is formed of the electrode current collector, the conductive member may be made of a metal portion of the electrode current collector where the electrode material is not provided. When the conductive member is formed of a current collecting lead, the conductive member may be formed of a metal member having a thin form and/or a long form. In the present embodiment, the conductive member electrically connecting the electrode assembly 10 and the electrode terminal to each other can also be referred to as a “tab”. The conductive member used for the secondary battery 1000 preferably has flexibility, and it may be provided in a warped form and/or a bent form.

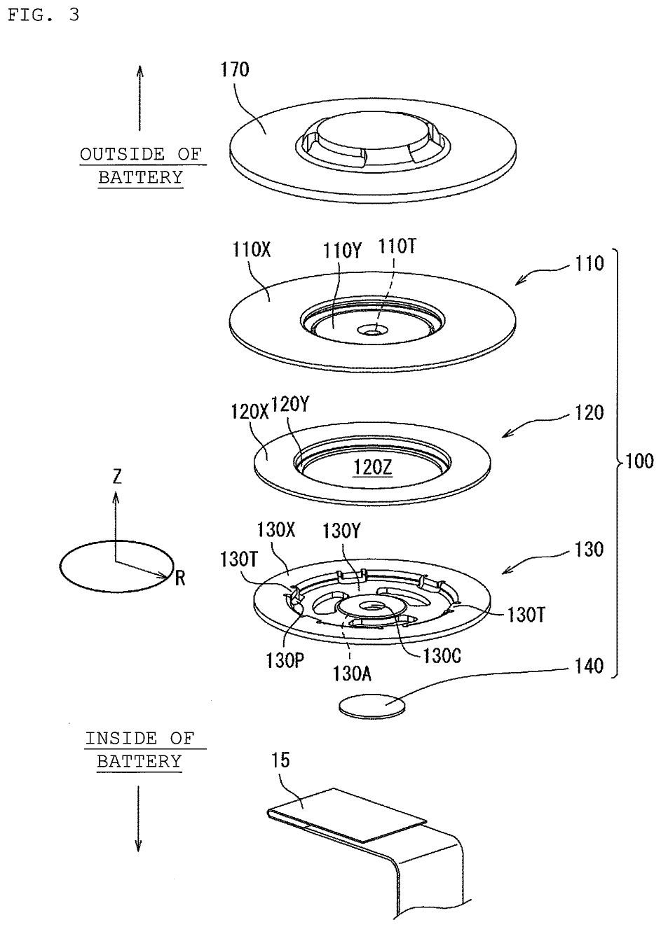

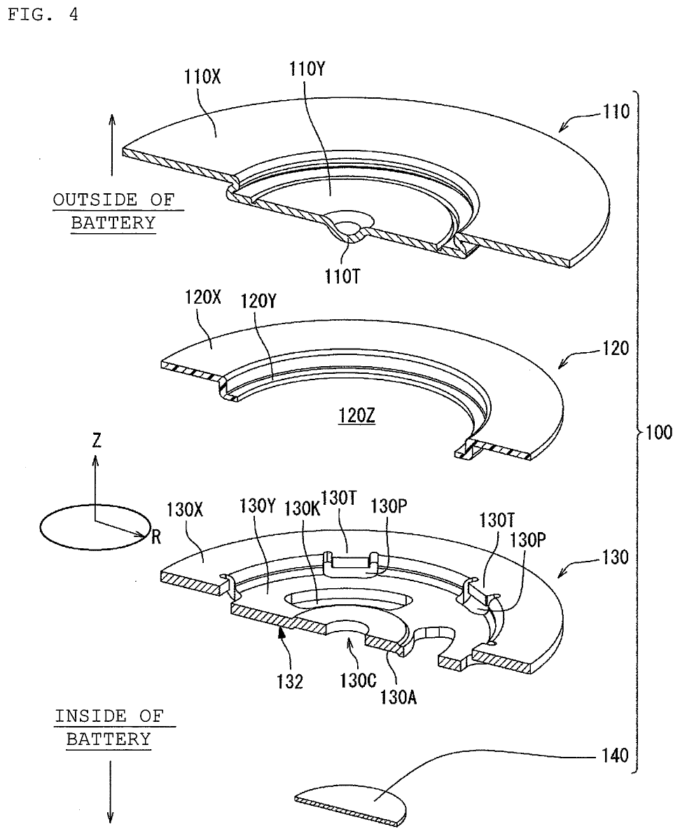

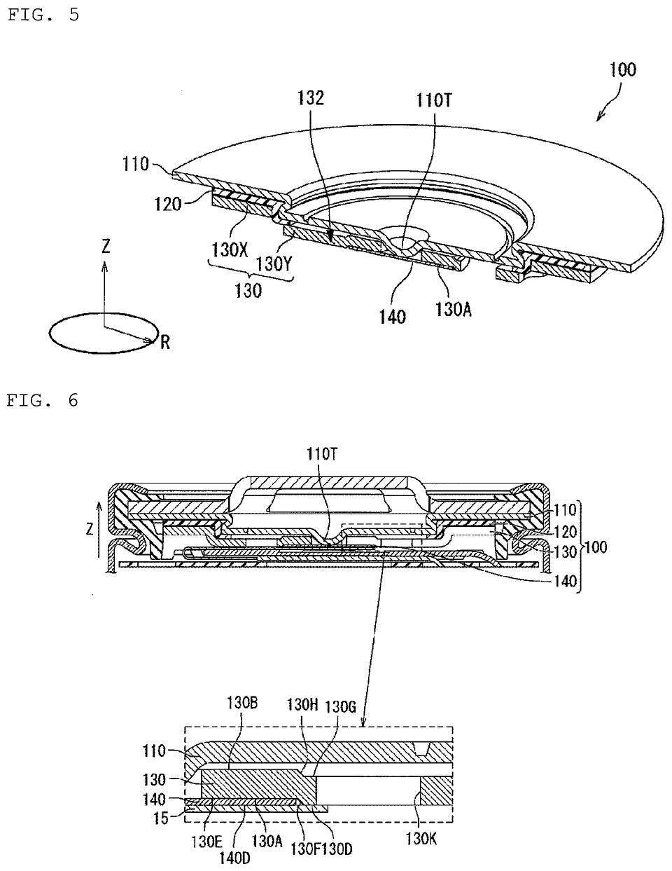

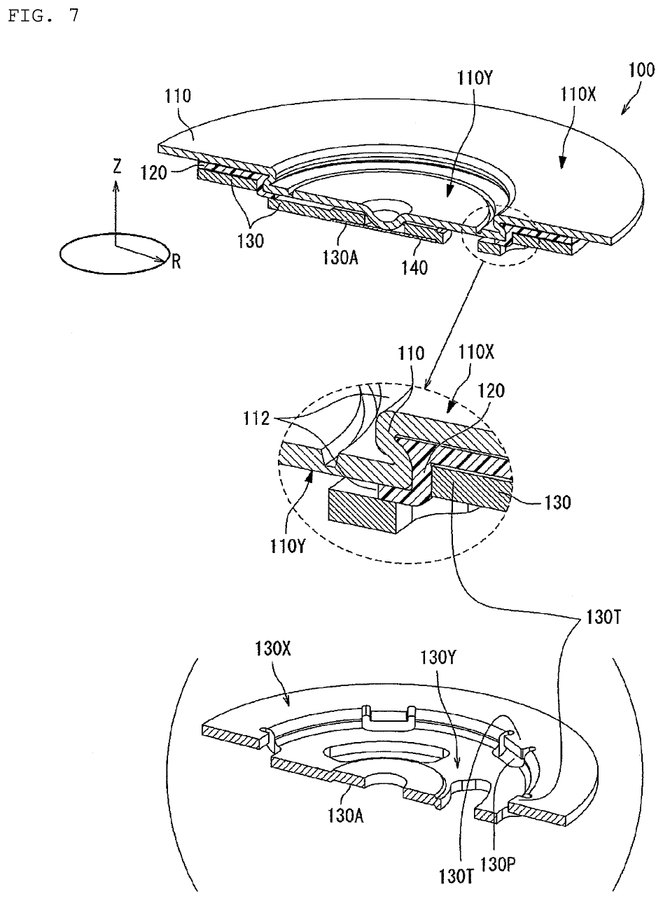

A first embodiment of the present disclosure relates to the secondary battery 1000. The secondary battery 1000 will be described with reference to FIGS. 3 to 7 in addition to FIGS. 1 to 2. FIG. 3 is a schematic perspective view illustrating constituent members and related members of the safety valve 100 of the secondary battery 1000 according to the first embodiment in a developed state. FIG. 4 is a schematic perspective view illustrating the constituent members of the safety valve 100 of the secondary battery 1000 according to the first embodiment cut in a half in a developed state. FIG. 5 is a schematic perspective view illustrating the safety valve 100 of the secondary battery 1000 according to the first embodiment cut in a half. FIG. 6 is a schematic sectional view of the safety valve 100 of the secondary battery 1000 according to the first embodiment. FIG. 7 is a schematic view illustrating a suitable combination state (connection state) of the members in the safety valve 100.

The secondary battery 1000 according to the first embodiment has a characteristic related to a safety mechanism. In particular, the safety valve 100 provided at the open end 51 of the secondary battery 1000 of the first embodiment is characterized. Specifically, in the secondary battery 1000, the safety valve 100 has at least a configuration in which a safety cover 110 having a protrusion 110T (protruding toward the relatively inner side of the battery axis) at the center, a disk holder 120 having an opening at the center, a stripper disk 130 having a cavity 130C at the center, and a sub disk 140 joined to the protrusion 110T extending through the opening of the disk holder and the cavity of the stripper disk are combined in order from the relatively outer side to the inner side of the housing member (in the battery axial direction). The stripper disk 130 has a recess 130A on a surface located on the relatively inner side of the housing member (of the battery axis), and the recess 130A houses the sub disk 140.

The safety valve 100 does not operate in normal use, but operates at the time of abnormality. Specifically, the safety valve 100 can suppress and avoid battery smoking and/or battery firing caused by an abnormal temperature undesirably increased due to, for example, a short circuit (at the time of abnormality). Details of the operation of the safety valve will be described later.

The secondary battery 1000 according to the first embodiment has further improved vibration resistance according to an embodiment.

A related art will be described first with further reference to FIG. 9. FIG. 9 is a schematic sectional view of a safety valve 100 of a conventional secondary battery. As illustrated in FIG. 9, in a secondary battery 1000z of the related art, a stripper disk 130z has no recess. The sub disk 140 is disposed in contact with the lower surface of the stripper disk 130z. When vibration is applied to such a secondary battery 1000z, the electrode assembly collides with the sub disk 140 inside the secondary battery 1000z, and thus stress concentrates on the joint portion between the safety cover 110 and the sub disk 140 and the periphery thereof. This may damage the joint portion between the safety cover 110 and the sub disk 140.

On the other hand, the sub disk 140 of the secondary battery 1000 according to the first embodiment is housed in the recess 130A of the stripper disk 130. With this configuration, when vibration is applied to the secondary battery 1000, the electrode assembly collides with not only the sub disk 140 but also the stripper disk 130 in the secondary battery 1000, and thus stress is dispersed in the stripper disk 130, and stress on the joint portion between the safety cover 110 and the sub disk 140 and the periphery thereof is reduced.

The secondary battery according to the first embodiment thus has further improved vibration resistance according to an embodiment.

Since the secondary battery 1000 has further improved vibration resistance as described above, the secondary battery 1000 is less likely to be damaged during normal use. An appropriate operation when the safety valve 100 at the time of abnormality can be more reliably ensured.

In the related art, it has been found that when an external stress is applied to the safety valve 100 because of application of an impact to the secondary battery 1000 due to falling or the like and application of vibration to the secondary battery 1000 in transportation or the like, the applied external stress concentrates on the joint portion between the safety cover 110 and the sub disk 140 and the periphery thereof (place where the safety valve 100 operates at the time of abnormality (more specifically, a portion where the safety cover 110 and the sub disk 140 are displaced and broken)), and the joint portion and the periphery thereof may be damaged.

The present disclosure, in an embodiment, relates to providing a technique of suppressing concentration of external stress on the joint portion between the safety cover 110 and the sub disk 140 and the periphery thereof and dispersing the external stress. Based on such an idea, the inventor of the present disclosure conducted further intensive studies, such as, a component of the external stress in the Z direction around the joint portion by providing the recess 130A in the stripper disk 130 and housing the sub disk 140 in the recess 130A. The secondary battery 1000 according to the first embodiment with “the stripper disk 130 having a recess 130A on a relatively inner surface of the battery shaft, the recess 130A housing the sub disk 140” having further improved vibration resistance.

As illustrated in FIGS. 3 and 4, the safety valve 100 has a configuration in which the safety cover 110, the disk holder 120, the stripper disk 130, and the sub disk 140 are combined with each other in this order along the Z direction. When viewed along the axial direction of the cylindrical shape of the battery, the safety cover 110 is positioned relatively outside the battery (that is, for example, a side farther from the electrode assembly 10 such as a wound structure), and the sub disk 140 is positioned relatively inside the battery (that is, for example, a side closer to an electrode assembly such as a wound structure). In other words, the disk holder 120 is positioned on the inner sider of the battery with respect to the safety cover 110, the stripper disk 130 is positioned on the inner side of the battery with respect to the disk holder 120, and the sub disk 140 is positioned on the inner side of the battery with respect to the stripper disk 130.

Each member constituting the safety valve 100 will be described. The safety valve 100 contributes to a battery terminal (that is, one of the positive electrode terminal and the negative electrode terminal as the external terminals of the battery) and has at least a mechanism that can be displaced and broken because of an excessive battery internal pressure (for example, the safety cover 110 and/or the sub disk 140 can be displaced and broken). Thus, the safety valve includes at least the safety cover 110, the disk holder 120, the stripper disk 130, and the sub disk 140 as components. The safety valve 100 may be provided at the open end of the battery can 50 (the open end 51 in the case of the battery can 50 of FIGS. 1 and 2).

The safety cover 110 is disposed on the relatively outer side of the battery axis of the disk holder 120. The safety cover 110 closes the open end 51 of the battery can 50 and can be deformed and/or displaced in an openable manner in response to an increase in the internal pressure of the battery can 50. The internal pressure of the battery can 50 may increase because of a side reaction such as a decomposition reaction of the electrolytic solution, for example. Since a gas such as carbon dioxide is generated inside the battery can 50 when a side reaction such as a decomposition reaction of the electrolytic solution occurs, the internal pressure of the battery can 50 undesirably increases according to an increase of the generation amount of the gas.

The safety cover 110 includes a central portion 110Y having a substantially circular shape and an outer peripheral portion 110X disposed on a peripheral edge of the central portion 110Y. The central portion 110Y is recessed toward the relatively inner side (that is, toward the disk holder 120) of the battery axis with respect to the ring-shaped outer peripheral portion 110X. The central portion 110Y is closer to the disk holder 120 than the outer peripheral portion 110X.

The planar shape of the central portion 110Y, in particular, the outer contour shape (hereinafter, also referred to as “outer contour shape in plan view”) in plan view is not particularly limited, but is, for example, similar to the outer contour shape in plan view of the safety cover 110. In the illustrated aspect, the outer contour shape of the central portion 110Y in plan view is circular. The central portion 110Y can be displaced in accordance with an increase in the internal pressure of the battery can 50. When the internal pressure of the battery can 50 rises to exceed a predetermined pressure, such as at the time of abnormality, the central portion 110Y of the safety cover 110 may be deformed and/or broken (cleaved), for example. Such a substantially central portion of the central portion 110Y is, for example, further recessed toward the disk holder 120. In other words, the central portion 110Y is provided with, for example, a protrusion 110T that protrudes toward relatively inner side of the battery (that is, for example, a direction in which an electrode assembly such as a wound structure is positioned). That is, in the secondary battery 1000, the protrusion 110T protrudes toward the sub disk 140.

The central portion 110Y has the protrusion 110T protruding from the central portion 110Y toward the relatively inner side the battery axis at the center thereof. The protrusion 110T is joined to the sub disk 140 through the disk holder 120 and the cavities 120Z and 130C of the stripper disk 130. Thus, the safety cover 110 is electrically connected to the sub disk 140 through the joint portion.

At the time of abnormality of the secondary battery 1000, the internal pressure increases inside the sealed battery because of the gas generated inside the battery. The increased internal pressure causes the central portion 110Y of the safety cover 110 to be displaced to the relatively outer side of the battery axis. When the internal pressure further increases, a groove 115 of the safety cover 110 breaks, and a part of the central portion 110Y is displaced toward the relatively outer side of the battery axis. As a result, the electrical connection between the broken central portion 110Y and the outer peripheral portion 110X is cut off.

The outer contour shape of the safety cover 110 in plan view is not particularly limited, and is, for example, a circle, a polygon, or other shapes. The circular shape is, for example, a true circle (perfect circle), an ellipse, a substantial circle, or the like. The substantial circle is, for example, a generic name of a some or all distorted shape of a true circle. The polygons are, for example, triangles, squares, pentagons and hexagons. The other shapes are, for example, shapes other than a circle whose contour is formed only by a curve, shapes in which two or more types of polygons are combined, and shapes in which one or more types of circles and one or more types of polygons are combined. Such a definition of “circular” and the like is the same hereinafter. In the illustrated exemplary embodiment, the outer contour shape of the safety cover 110 in a plan view is circular.

The safety cover 110 may be a metal member. For example, the safety cover 110 may include any one of, or two or more of metal materials such as aluminum and an aluminum alloy.

The central portion 110Y of the safety cover 110 can be fitted into the disk holder 120 (in particular, a recess thereof). That is, the safety cover 110 can be fixed to the disk holder 120 while the safety cover 110 is aligned with the disk holder 120. Since the disk holder 120 also contributes to the fixing of the stripper disk 130, the safety cover 110 and the stripper disk 130 are fixed to each other via the disk holder 120.

The disk holder 120 is interposed between the safety cover 110 and the stripper disk 130, and insulates electrical connection between the outer peripheral portions 110X and 130X. As a result, the electrical connection between the safety cover 110 and the stripper disk 130 in the safety valve 100 is limited to only the connection via the joint portion, and in the safety mechanism of the safety valve 100 described later, the joint portion is displaced at the time of abnormality to enable cutting off of the electrical connection.

The disk holder 120 can also be interposed between the safety cover 110 and the stripper disk 130 to align the stripper disk 130 with respect to the safety cover 110.

The disk holder 120 includes a substantially circular cavity 120Z at the center, a ring-shaped inner peripheral portion 120Y disposed on a peripheral edge of the cavity 120Z, and a ring-shaped outer peripheral portion 120X disposed on a peripheral edge of the inner peripheral portion 120Y.

The disk holder 120 may have an annular shape (more specifically, in a plan view, it has an annular shape or a ring shape) with a cavity in the center. The annular shape of the disk holder 120 is not particularly limited, but may be the same as the outer contour shape of the safety cover 110 in plan view. The outer edge of the disk holder 120 may be, for example, circular.

The inner peripheral portion 120Y is disposed so as to be recessed toward the relatively inner side the battery axis (toward the stripper disk 130 in the safety valve 100) with respect to the outer peripheral portion 120X. That is, the inner peripheral portion 120Y is closer to the stripper disk 130 side than the outer peripheral portion 120X. The outer contour shape in plan view and the inner contour shape in plan view of the inner peripheral portion 120Y are not particularly limited, but each may be, for example, similar to the outer contour shape in plan view of the safety cover 110. In the illustrated example mode, each of the outer contour shape in plan view and the inner contour shape in plan view of the inner peripheral portion 120Y is circular.

The member constituting the disk holder 120 includes an insulating member (for example, a resin member). In a preferred aspect, the insulating member is a resin member. Examples of the resin member include thermoplastic resins (more specifically, polypropylene (PP) and polybutylene terephthalate (PBT)). In a preferred aspect, when the insulating member is a resin member, the shape of the disk holder 120 may be deformed with external stress applied to the secondary battery 1000. For this reason, concentration of external stress on specific members and portions is reduced and dispersed, and undesired breakage in normal times is suppressed.

The disk holder 120 has the cavity 120Z at a position corresponding to the central portion 110Y of the safety cover 110. The cavity 120Z corresponds to an opening region providing an annular shape to the disk holder 120. The opening shape of the cavity 120Z (in particular, in a plan view, the planar opening shape) is not particularly limited, and may be, for example, the same as the outer contour shape of the safety cover 110 in plan view. In the illustrated exemplary embodiment, the opening shape of the cavity 120Z of the disk holder 120 is circular.

The disk holder 120 is preferably a resin member. That is, the disk holder 120 preferably contains a resin component. This allows the safety valve 100 to be easily displaced in a preferable manner by external stress in manufacturing. That is, the disk holder 120 is easily displaced suitably by the pressing force caused by the protrusion of the stripper disk 130, and the safety cover 110 and the stripper disk 130 are easily fixed suitably to each other through the displaced disk holder 120. The specific resin component of the disk holder 120 is not particularly limited, and examples thereof include at least one selected from the group consisting of polyethylene resin, polypropylene resin, polystyrene resin, ABS resin (acrylonitrile (A)-butadiene (B)-styrene (S) resin), vinyl chloride resin, polymethyl methacrylate resin, polyethylene terephthalate resin, polyamide resin, polycarbonate resin, polyacetal resin, a polybutylene terephthalate resin, a modified polyphenylene ether resin, polyphenylene sulfide resin, liquid crystal polymers, polyarylate resin, polysulfone resin, polyether sulfone resin, polyether ether ketone resin, and the like. In a preferred aspect, the disk holder 120 contains a polybutylene terephthalate resin (PBT).

The stripper disk 130 is interposed between the disk holder 120 and the sub disk 140, and contributes to the passage or release of gas generated inside the battery can 50.

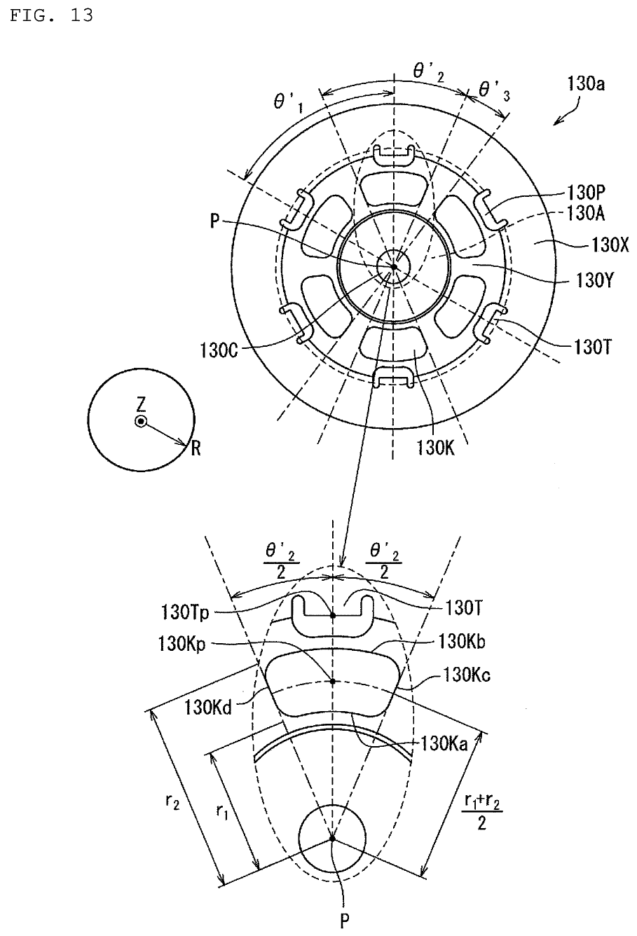

As illustrated in FIG. 12, the stripper disk 130 includes a central portion 130Y having a substantially circular shape in plan view, and an outer peripheral portion 130X disposed on a peripheral edge of the central portion 130Y so as to surround the central portion 130Y.

The thickness of the stripper disk 130 is 0.35 to 0.40 mm in a preferred aspect. When the thickness of the stripper disk is 0.35 mm or more, the stripper disk 130 has appropriate strength, and an undesired operation of the safety mechanism in normal times is less likely to occur. Thus, in such a case, vibration resistance is further improved. When the thickness of the stripper disk is 0.40 mm or less, the material of the raw material of the stripper disk 130 is appropriately thin, and thus the stripper disk 130 is hardly worn by the punching machine, and the cost is excellent.

In a preferred aspect, the material constituting the stripper disk 130 has a tensile strength of 230 to 290 N/mm² obtained by a tensile test in accordance with Japanese Industrial Standard (JIS) Z2241. When the material constituting the stripper disk 130 has a tensile strength of 230 N/mm² or more, the stripper disk 130 has an appropriate strength, and undesired operation of the safety valve 100 in normal times is less likely to occur. Thus, in such a case, vibration resistance is further improved.

On the other hand, when the material constituting the stripper disk 130 has a tensile strength of 290 N/mm² or less, since the thickness of the material of the raw material of the stripper disk 130 is appropriately thin, the stripper disk 130 is hardly worn by the punching machine, and the cost is excellent.

The thickness of the stripper disk 130 is substantially constant. In the present specification, the thickness of the stripper disk 130 refers to a length from the upper surface to the lower surface of the stripper disk 130 in the Z direction. The thickness of the stripper disk 130 is, for example, a length in the Z direction from the outer upper surface 130B to the inner lower surface 130E.

The central portion 130Y includes a cavity 130C having a substantially circular shape whose center coincides with the battery axis, a recess 130A disposed on a peripheral edge of the cavity 130C so as to surround the cavity 130C, a plurality of cavities 130K concentrically disposed on the peripheral edge of the recess 130A, a plurality of protrusions 130T and a plurality of cavities 130P disposed in the vicinity of an interface between the central portion 130Y and the outer peripheral portion 130X.

The outer peripheral portion 130X is disposed on the peripheral edge of the central portion 130Y so as to surround the central portion 130Y. The outer peripheral portion 130X is disposed on the relatively outer side of the battery axis with respect to the central portion 130Y. The outer peripheral portion 130X is connected to the central portion 130Y by a step portion.

The recess 130A is provided on the second surface side of the stripper disk 130. The recess 130A is disposed so as to surround the peripheral edge of the cavity 130C of the stripper disk 130. The recess 130A is disposed so as to protrude toward the relatively outer side of the battery axis as compared with the central portion 130Y other than the recess 130A. The recess 130A (inner space) is defined by an inner lower surface 130E and an inner side surface 130F of the recess 130A. The disk holder 120 is housed in (the space inside) the recess 130A.

Since the recess 130A of the stripper disk 130 houses the disk holder 120, when external stress is applied to the secondary battery 1000, the thickness in the Z direction decreases by the amount of the disk holder 120 housed in the recess 130A. Thus, the external stress (in particular, the component of the external stress in the Z direction) is reduced, and concentration on the joint portion of the safety valve 100 is suppressed. Therefore, the secondary battery 1000 has further improved vibration resistance.

In a preferred aspect, the inner diameter of the recess 130A is larger than the diameter (outer diameter) of the sub disk 140 as illustrated in the enlarged sectional view of FIG. 6. That is, for the diameter of the sub disk 140, when the inner diameter of the recess 130A, which is smaller than the diameter of the recess 130A (inside the recess), is smaller than the outer diameter of the disk holder 120, the difference (gap or clearance) between the inner diameter of the recess 130A and the outer diameter of the disk holder 120 functions as “allowance”. In this case, when external stress is applied to the safety valve 100 of the secondary battery 1000, the disk holder 120 can move in the radial direction. Thus, the applied external stress is less likely to concentrate on a specific portion (for example, the joint portion and its periphery) of the safety valve 100, thus the safety valve is less likely to be damaged, and the vibration resistance further improves. The inner diameter of the recess 130A may be smaller by, for example, 99%, 98%, 97%, 96%, or 95%, when the outer diameter of the sub disk 140 is 100%.

The inner diameter of the recess 130A increases toward the relatively inner side of the battery axis in a preferred aspect. That is, the inner side surface 130F of the recess 130A is inclined with respect to the battery axis in sectional view such that the inner diameter of the recess 130A increases toward the relatively inner side of the battery axis. In this manner, the recess 130A can have a tapered shape. In this case, when external stress (in particular, the radial component of the external stress) is applied to the safety valve 100 of the secondary battery 1000, the disk holder 120 can further move in the radial direction. Thus, the applied stress is less likely to concentrate on a specific portion (for example, the joint portion and its periphery) of the safety valve 100, the safety valve is further less likely to break, and thus vibration resistance further improves. The inclination angle of the inner side surface 130F of the recess 130A may be, for example, an angle of 100°, 110°, 120°, 130°, 140°, or 150° with respect to the inner lower surface 130E of the recess 130A.

The inner side surface 130F forms a straight line in FIG. 6 in a sectional view, but at least a part thereof may form a curved surface.

The stripper disk 130 has a plurality of cavities 130K disposed radially from a center point (opening center point) P of the stripper disk 130 in plan view, and a plurality of protrusions 130T and a plurality of cavities 130P disposed on an outer edge side of the cavities 130K in the radial direction from the center point P. The center point P of the stripper disk 130 is a point overlapping the battery axis in plan view in the present specification.

The plurality of cavities 130K, the plurality of protrusions 130T, and the plurality of cavities 130P are disposed concentrically with respect to the center point P.

The cavity 130K includes two straight lines parallel to a straight line extending in the radial direction from the center point P, a part (curve) of a circle having predetermined radiuses r₁ and r₂ with respect to the center point P, and a connecting portion. The connecting portion connecting the straight line and the curved line is rounded. The two straight lines constituting the cavity 130K intersect when rotated by an angle θ₂ with respect to the center point P. The two straight lines constituting the cavity 130K are disposed apart from each other by the rotation of the angle θ₂ with respect to the center point P. That is, the cavity 130K has an angular width of the angle θ₂ with respect to the center point P. The two curves constituting the cavity 130K are parts of two circles having predetermined different radiuses r₁ and r₂ with respect to the center point P. The two curves constituting the cavity 130K are disposed to face each other in the radial direction and to be separated from each other by the difference of the two radiuses (r₂−r₁). That is, the cavity 130K has a radial width of the difference of the two radiuses.

The plurality of cavities 130K have the same shape. The plurality of cavities 130K are disposed at equal intervals with respect to the center point P, and the cavities 130K overlap the adjacent cavities 130K when rotated by an angle θ₁ with respect to the center point P. In other words, the disposition of the plurality of cavities 130K is a three-fold symmetry C₃. The adjacent cavities 130K are separated from the adjacent cavities 130K at an angle θ₃ rotation interval with respect to the center point P.

The plurality of cavities 130P and the plurality of protrusions 130T are formed together by, for example, punching a part of a two-dimensional material (a recess shape in plan view in FIG. 12). Thus, when such a forming method is adopted, the cavity 130P and the protrusion 130T forms a pair.

There are six pairs of the cavity 130P and the protrusion 130T. These six pairs are disposed at equal angles with respect to the center point P, and overlap adjacent pairs when any pair is rotated by an angle θ₁/2 with respect to the center point P. That is, in other words, the disposition of the plurality of cavities 130P and the plurality of protrusions 130T has a six-fold symmetry C₆.

The six pairs include three pairs having the disposition relationship of the three-fold symmetry C₃ and the other three pairs having the disposition relationship of the three-fold symmetry C₃. The three pairs are disposed so as to face the cavity 130K in the radial direction. The number of the cavities 130K is 3, the number of the protrusions 130T is 6, and these numbers are different from each other.

(A center point 130Tp of) the protrusion 130T and (a center point 130Pp of) the cavity 130P are present on a broken line extending from the center point P in the radial direction through the center point 130Kp of the cavity 130K. Here, the broken line is a straight line (in FIG. 12, a straight line indicated by a broken line) located at an angle θ₂/2 that is a half of the angle θ₂ formed by two straight lines constituting the cavity 130K in a plan view of the stripper disk 130. The center point 130Kp of the cavity 130K is an intersection of the broken line and a part of a circle having a radius of an intermediate value (r₁+r₂)/2 of the radiuses (r₁ and r₂: r₁<r₂) of the two curves constituting the cavity 130K. The center point 130Tp of the protrusion 130T is an intersection of the broken line and the protrusion 130T, and is a point closest to the center point P.

The stripper disk 130 may be a metal member. For example, the stripper disk 130 may include any one or two or more of metal materials, such as aluminum and aluminum alloys, in a preferred aspect, aluminum or aluminum alloys. When the material of the stripper disk 130 is aluminum or an aluminum alloy, the strength of the stripper disk 130 can be further improved, the undesired operation of the safety valve 100 in normal times is suppressed, and thus the vibration resistance of the secondary battery 1000 improves.

The material of the stripper disk 130 may be the same as or different from the material of the safety cover 110. The outer contour shape of the stripper disk 130 in plan view is not particularly limited, but is, for example, similar to the outer contour shape of the safety cover 110 in plan view. In the illustrated exemplary embodiment, the outer contour shape of the stripper disk 130 in plan view is circular.

The outer contour shape of the central portion 130Y is not particularly limited, but may be the same as the outer contour shape of the safety cover 110 in plan view, and is, for example, circular. Since the central portion 130Y of the stripper disk 130 is lower than the outer peripheral portion 130X, the central portion 130Y is closer to the sub disk 140 than the outer peripheral portion 130X. The inner peripheral portion 120Y of the disk holder 120 can be fitted to the stripper disk 130 (in particular, a recess thereof). As a result, the stripper disk 130 is aligned with the disk holder 120, and thus can be fixed to the safety cover 110 with the disk holder 120 interposed therebetween.

In the central portion 130Y of the stripper disk 130, for example, a plurality of cavities 130K are provided in a region facing the central portion 110Y of the safety cover 110. The plurality of cavities 130K mainly correspond to ventilation ports that contribute to passage or release of gas inside the battery can 50. In the stripper disk 130, the outer peripheral portion 130X is provided with a plurality of protrusions 130T protruding toward the center of the disk (the center of the member in plan view). The plurality of protrusions 130T are disposed on the outer side with respect to the plurality of cavities 130K. As illustrated in the drawing, such a protrusion 130T overhangs or protrudes in a “claw” shape in the stripper disk 130. The plurality of protrusions 130T are mainly used to suitably fix the stripper disk 130 to the disk holder 120. In this case, for example, as illustrated in FIG. 7, because of the pressing action of the plurality of protrusions 130T on the outer side surface of the disk holder 120, the inner side surface of the disk holder 120 has a pressing action on the safety cover 110. As a result, a suitable fitting force via the disk holder 120 is generated between a part of the stripper disk 130 (in particular, the plurality of protrusions 130T) and the safety cover 110, and the stripper disk 130 and the safety cover 110 are suitably fixed to each other by the fitting force.

The illustrated stripper disk 130 has, for example, a form in which the stripper disk 130 is removed in a part in a range from the outer peripheral portion 130X to the central portion 130Y. That is, the cavity 130P (in particular, the cavity 130P extending from the outer peripheral portion 130X to the central portion 130Y) is provided in the stripper disk 130. In a preferred aspect, the cavity 130P is provided in association with the installation of the protrusion 130T (for example, it can be provided when the stripper disk 130 including the protrusion 130T is press-molded). Thus, in the stripper disk 130, the cavity 130P may be provided adjacent to the inner peripheral side portion of the outer peripheral portion 130X, and the protrusion 130T may be provided adjacent to the cavity 130P. In other words, it can be said that the plurality of cavities 130P are provided so as to correspond to the plurality of protrusions 130T, respectively. In the stripper disk 130, the number of the cavities 130P is not particularly limited, and the number of the protrusions 130T is not particularly limited either. In the illustrated aspect, the number of the cavities 130P is, for example, 6, and the number of the protrusions 130T is also, for example, 6.

In the central portion 130Y of the stripper disk 130, for example, the cavity 130C (in particular, a cavity different from the cavities 130K and 130P) for allowing the protrusion 110T to pass is provided at a position corresponding to the protrusion 110T of the safety cover 110. Thus, the protrusion 110T of the safety cover 110 is physically connected to the sub disk 140 through the cavity 130C (particularly, through passing in a non-contact state with the stripper disk). The opening shape of the cavity 130C (in particular, in a plan view, the planar opening shape) is not particularly limited, and may be, for example, the same as the outer contour shape of the safety cover 110 in plan view. In the illustrated aspect, the opening shape of the cavity 130C of the stripper disk 130 is circular. Each of the plurality of cavities 130K, the plurality of protrusions 130T, and the plurality of cavities 130P may be disposed, for example, at a position on a concentric circle centered on the cavity 130C.

The sub disk 140 is a member that can be disposed between the stripper disk 130 and the electrode assembly 10. The sub disk 140 has a first surface 140C disposed on the relatively outer side of the battery axis and a second surface 140D disposed on the relatively inner side of the battery axis and facing the first surface 140C. The first surface 140C of the sub disk 140 is joined to the protrusion 110T of the safety cover 110. The second surface 140D of the sub disk 140 is in contact with the conductive member 15. This causes the sub disk 140 to be electrically connected to the safety cover 110 and the conductive member 15. In other words, the sub disk 140 electrically connects the electrode assembly (in particular, the conductive member 15 such as a tab or a lead thereof) 10 and the safety cover 110 (in particular, the protrusion 110T thereof) to each other.

Since the sub disk 140 is housed in the recess 130A of the stripper disk 130, it may have a shape corresponding to the internal space of the recess 130A of the stripper disk 130. The sub disk 140 has, for example, a circular shape.

The diameter of the sub disk 140 is larger than the opening diameter of the cavity 130C of the stripper disk 130. In this manner, the stripper disk 130 and the sub disk 140 cut off communication of the internal space of the secondary battery 1000, and the safety valve 100 to be described later is operated when the internal pressure has increased.

The diameter of the sub disk 140 is, in a preferred aspect, less than the recess diameter of the recess 130A of the stripper disk 130. Here, in the present specification, the recess diameter refers to the inner diameter of the recess 130A and the diameter of the inner upper surface of the recess 130A. When the diameter of the sub disk 140 is less than the recess diameter of the recess 130A of the stripper disk 130, there is a clearance between the outer edge of the stripper disk 130 and the inner side surface 130F of the recess 130A. Thus, when an external stress is applied to the secondary battery 1000, the sub disk 140 can slide with respect to the recess 130A. In this manner, the safety valve 100 can reduce and disperse the external stress applied to the safety valve 100 (in particular, the joint portion between the safety cover 110 and the sub disk 140 and its periphery) with respect to the external stress (in particular, a radial component of the external stress). Such stress concentration is suppressed, and vibration resistance is improved.

In a preferred aspect, the terminal (conductive member) 15 of the battery element 10 comes into contact with the second surface 140D of the sub disk 140 and the outer lower surface 130D of the recess 130A of the stripper disk 130. In this manner, since the sub disk 140 is housed in the recess 130A, the conductive member 15 comes into contact with not only the sub disk 140 but also the stripper disk 130. On the other hand, in the conventional secondary battery 1000z, the sub disk 140 comes into contact with only the sub disk 140 as illustrated in FIG. 9. In this manner, since the conductive member 15 can increase the contact area with other members, the electrical connection can be more reliably performed as compared with the conventional secondary battery 1000z.

In a preferred aspect, the second surface 140D of the sub disk 140 is flush with the outer lower surface 130D of the recess 130A of the stripper disk 130. The second surface 140D of the sub disk 140 and the outer lower surface 130D of the recess 130A of the stripper disk 130 are in contact with and electrically connected to the conductive member 15. Thus, in the case of being flush as described above, the conductive member 15 easily comes into contact with the second surface 140D of the sub disk 140 and the outer lower surface 130D of the recess 130A of the stripper disk 130, and more reliable electrical connection can be realized.

The sub disk 140 may be a metal member. The sub disk 140 may include, for example, any one of, or two or more of metal materials such as aluminum and an aluminum alloy. The material of the sub disk 140 may be the same as or different from the material of the safety cover 110.

The safety valve 100 has a configuration in which a plurality of members are combined, and the present embodiment has unique matters related to the combination. As described above, in the safety valve 100, the fitting method using the protrusion 130T of the stripper disk 130 is preferably adopted. More specifically, the safety cover 110 and the stripper disk 130 are fixed to each other with the disk holder 120 interposed therebetween by the pressing force and the fitting force caused by the protrusion 130T of the stripper disk 130. Taking the aspect illustrated in FIG. 7 as an example, the safety cover 110 and the stripper disk 130 are fixed while being insulated from each other with the disk holder 120 interposed therebetween by the pressing force provided due to the protrusion 130T (for example, a claw-like portion as illustrated in the drawing) with the cavity 130P. Here, the safety cover 110 is preferably provided such that a side wall thereof (more specifically, a side wall portion between the outer peripheral portion 110X and the central portion 110Y) forms an angle with respect to the axis of the secondary battery 1000, and in short, preferably has a form of a “Z folding” 112. Such a “Z folding” 112 of the safety cover 110 contributes to more effectively acting the pressing force caused by the protrusion 130T of the stripper disk 130, and the safety cover 110 and the stripper disk 130 can be more effectively fixed with the disk holder 120 interposed therebetween. As described above, the cavity 130P is provided in the vicinity of the protrusion 130T of the stripper disk 130 so as to be adjacent to the protrusion, which relates to manufacturing of the stripper disk 130 including the protrusion 130T by press molding. That is, the stripper disk 130 is preferably a press component, and the cavity 130P is formed by providing the protrusion 130T as illustrated as the press component.

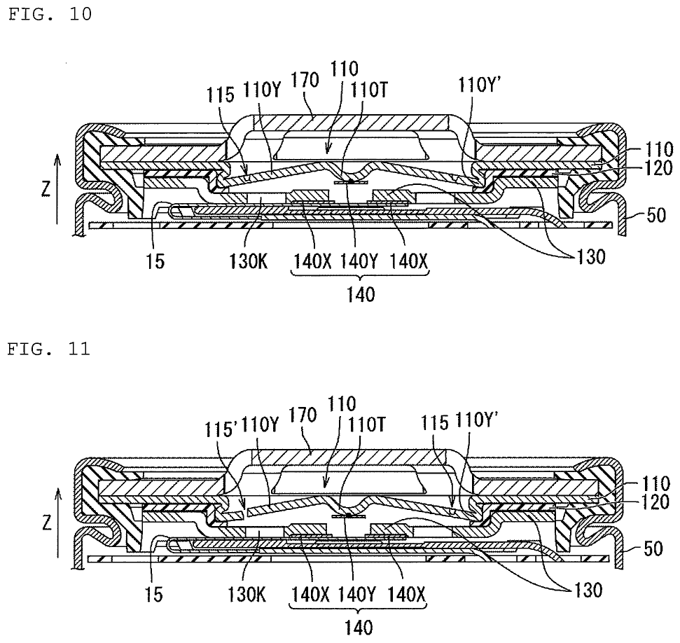

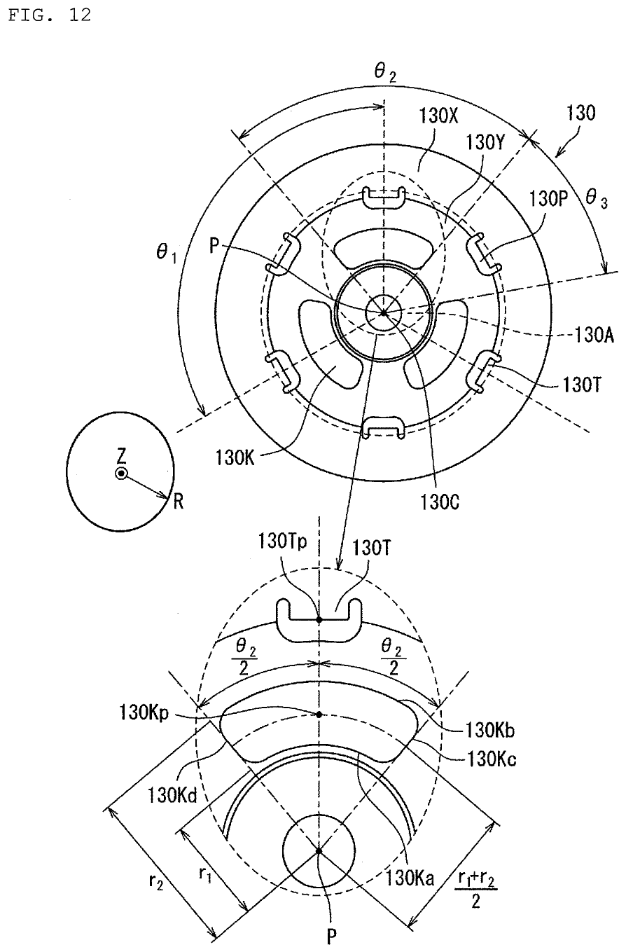

With reference mainly to FIGS. 10 and 11 in addition to FIG. 6, the effect of the secondary battery 1000 according to the present embodiment will be described in more detail in relation to the abnormality of the secondary battery 1000. FIG. 10 is a schematic sectional view illustrating a state of an operated safety valve. FIG. 11 is a schematic sectional view illustrating a state of the safety valve that is further operated from the state illustrated in FIG. 10.

As described above, when an abnormality of the increase in the internal pressure occurs inside the battery due to a short circuit or the like, it is conceivable that the abnormality occurs in combination with an abnormality such as an increase in the internal pressure. That is, it is assumed that an increase in pressure inside the battery can 50 due to side reactions such as a decomposition reaction of the electrolytic solution or other factors becomes excessive along with an undesired increase in temperature inside the battery 1000. FIG. 6 also illustrates a state where the internal pressure (that is, the internal pressure of the battery can 50) of the battery during normal use is in a normal range, and the safety valve 100 is not operating. As illustrated in FIG. 6, the safety cover 110 is not yet displaced, and the gas flow path or the gas release path itself through the plurality of cavities 130K in the stripper disk 130 does not particularly function.

When a gas is generated due to a side reaction such as a decomposition reaction of the electrolytic solution inside the battery can 50, the gas is accumulated in the battery can 50, and thus the internal pressure of the battery can 50 increases. In addition, an increase in the internal pressure of the battery can 50 may also be caused by an undesired temperature increase in the inside of the battery such as a short circuit. When the internal pressure of the battery can 50 exceeds a certain predetermined pressure, the sub disk 140 is cleaved and divided as illustrated in FIGS. 10 to 11. Although not particularly limited, for example, the sub disk 140 is cleaved or divided due to its thinness (small thickness), and its central portion 140Y is separated from the peripheral portion (that is, the outer peripheral portion 140X). Then, due to the internal pressure of the battery can 50, the safety cover 110 is displaced so as to be at least lifted in a part while maintaining a state where the separated central portion 140Y of the sub disk 140 is connected to the protrusion 110T of the safety cover 110. In particular, the safety cover 110 is displaced (see FIG. 10) such that the central portion 110Y of the safety cover 110 bends more outward (for example, bends in an arcuate manner), and the battery internal pressure is reduced. When a groove (for example, a portion denoted by reference numeral “115” in the aspect illustrated in FIG. 10) is provided in the safety cover, the deflection of the safety cover 110 can be suitably operated by the groove. The groove 115 is provided on the relatively outer surface of the battery axis of the safety cover 110 and near a peripheral portion 110Y′ of the central portion.

The safety cover 110 and the outer peripheral portion 140X (in particular, the outer peripheral portion 140X to which the conductive member 15 such as a tab or a lead extending from the electrode assembly is still connected) of the sub disk 140 are physically separated from each other. As a result, the electrical connection between the battery cover 170 and the electrode assembly is cut, and the path of the current flowing between the electrode assembly 10 and the battery cover 170 is cut off. By cutting off the current, generation of gas inside the battery can be suppressed. During normal use, the safety cover 110 is electrically connected to the battery cover 170 forming an external terminal of the secondary battery 1000.

When the internal pressure in the secondary battery 1000 further increases and the displacement of the safety cover 110 further progresses, the safety cover 110 itself is cleaved or divided as illustrated in FIG. 11. The breaking portion 115′ of the safety cover 110 is derived from, for example, the groove 115 of the safety cover 110. As a result, the inside and the outside of the battery communicate with each other, and a gas release path through the plurality of cavities 130K of the stripper disk 130 is opened. The gas accumulated in the battery is discharged to the outside of the battery through the cavities 130K. The internal pressure of the battery is further reduced.

A method for producing the secondary battery 1000 will be exemplarily described. The secondary battery 1000 can be produced, for example, by the following procedure.

For producing the positive electrode 11, a positive electrode active material is mixed as necessary with a positive electrode binder, a positive electrode conductive agent, and the like to obtain a positive electrode mixture. Next, the positive electrode mixture is dispersed in an organic solvent or the like to obtain a paste-like positive electrode mixture slurry. Then, the positive electrode mixture slurry is applied to one side or both sides of the positive electrode current collector, and the positive electrode mixture slurry is dried to form a positive electrode active material layer. Thereafter, as necessary, the positive electrode active material layer may be compression-molded using a roll press machine or the like. In such a case, the positive electrode active material layer may be heated, or may be repeatedly compression-molded two or more times. The negative electrode 12 can be produced in the same manner. Specifically, a negative electrode active material, and, for example, a negative electrode binder and a negative electrode conductive agent are mixed to obtain a negative electrode mixture. Subsequently, the negative electrode mixture is dispersed in, for example, an organic solvent to obtain a negative electrode mixture slurry in a paste form. Next, a negative electrode active material layer is formed by applying the negative electrode mixture slurry to one or both surfaces of the negative electrode current collector and then drying the negative electrode mixture slurry. Thereafter, as necessary, the negative electrode active material layer is compression-molded using a roll press machine or the like.

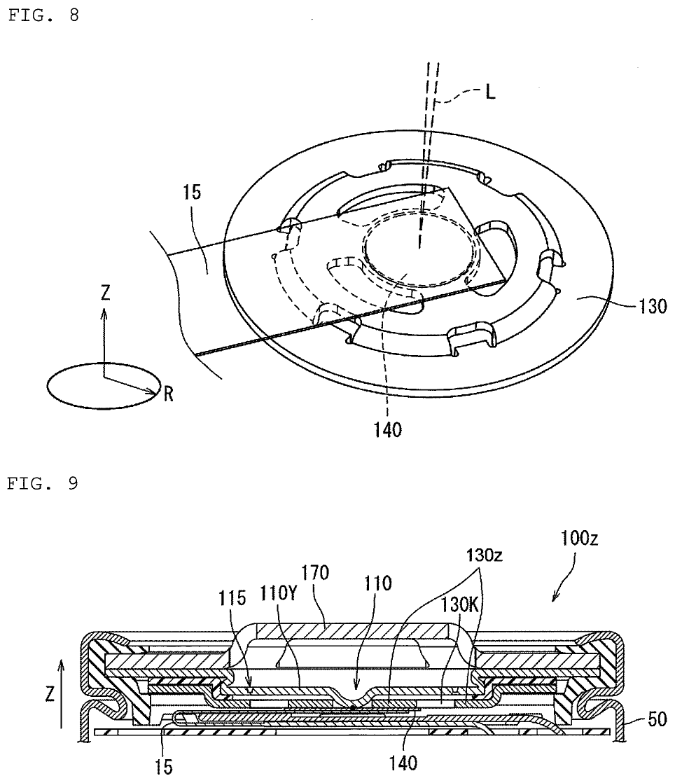

When the secondary battery 1000 is assembled, a positive electrode lead is connected to the positive electrode current collector by a welding method and the like and the negative electrode lead is also connected to the negative electrode current collector by a welding method and the like. Next, the positive electrode 11 and the negative electrode 12 are stacked with the separator 13 interposed therebetween, and then the positive electrode 11, the negative electrode 12, and the separator 13 are wound to form a wound electrode body 10. Next, the center pin is inserted into the winding space of the wound electrode body 10. Then, a wound electrode body 10 is sandwiched between a pair of insulating plates, and is contained inside the battery can 50 together with the pair of insulating plates. In this case, for example, as illustrated in FIG. 8, one end portion of the positive electrode lead (conductive member 15) is connected to the safety valve 100 by a welding method or the like, and one end portion of the negative electrode lead is connected in the same manner to the battery can 50 by a welding method or the like. Next, an electrolytic solution is injected into the battery can 50, and the wound electrode body 10 is impregnated with the electrolytic solution. Finally, a battery lid member (battery cover), a thermosensitive resistive element, and the safety valve are provided at the open end portion of the battery can with a gasket interposed therebetween through crimping. The secondary battery 1000 provided with the safety valve 100 is thus completed.

A secondary battery according to a second embodiment is different from the secondary battery 1000 according to the first embodiment in a stripper disk 130a. Hereinafter, this different configuration will be mainly described. In the second embodiment, the same reference numerals as those of the first embodiment denote the same configurations as those of the first embodiment, and thus the description thereof will be basically omitted.

Hereinafter, the secondary battery according to the second embodiment will be described with reference to FIG. 13. FIG. 13 illustrates the stripper disk 130a in the secondary battery 1000 according to the second embodiment.

The number of the cavities 130K and the number of the protrusions 130T are the same. The number of the plurality of cavities 130K and the number of the plurality of protrusions 130T are the same, and all of the plurality of protrusions 130T are disposed so as to face a corresponding one of the plurality of cavities 130K in the radial direction. That is, the protrusions 130T are disposed so as to face the same number of cavities 130K in the radial direction on a one-to-one basis. More specifically, the protrusion 130T has the center point 130Tp in a linear shape extending radially from the center point P through the center point 130Kp of the cavity 130K.

When the stripper disk 130a has such a shape (that is, when the number of the cavities 130K and the number of the protrusions 130T are the same and each pair of the cavities 130K and the protrusions 130T is disposed on a straight line extending in the radial direction from the center point P), the strength increases as compared with the stripper disk 130 of the first embodiment. Thus, in such a case, the vibration resistance of the secondary battery 1000 according to the second embodiment is further improved.

Although the embodiments of the present disclosure have been described herein, the present disclosure is not limited thereto.

In the second embodiment, the disposition of the plurality of cavities 130K is 6-fold rotational symmetry C₆, but the present disclosure is not limited to this configuration. For example, the plurality of cavities 130K may be disposed n-fold symmetrically Cn (n≠6: 2-fold symmetry C₂, 3-fold symmetry C₃, 4-fold symmetry C₄, 5-fold symmetry C₅, and 8-fold symmetry CB).

The safety valve 100 is provided with a battery lid member (that is, the battery cover), and the safety valve 100 may serve as a battery terminal (that is, one of the positive electrode terminal and the negative electrode terminal as the external terminals of the secondary battery 1000), particularly as a positive electrode terminal. That is, the safety valve 100 may be provided on the positive electrode terminal side of the battery can 50, and the safety valve 100 may be provided on the open end 51 of the battery can 50 on which the positive electrode terminal is provided. In such a case, the safety valve 100 is suitably combined with the positive electrode terminal to improve the convenience of the secondary battery 1000, which contributes to the realization of the more practically preferable secondary battery 1000.

The cylindrical secondary battery 1000 has been described, but the present disclosure is not necessarily limited to this configuration. For example, the secondary battery 1000 according to the first embodiment may be a battery having another shape such as a rectangular battery, and the effect of the present disclosure can be similarly exhibited.

Aspects of the secondary battery of the present disclosure are as follows according to an embodiment.

<1>

A secondary battery including:
a battery element;
an exterior member that houses the battery element; and
a safety valve attached to the exterior member,
wherein the safety valve includes at least a configuration in which a safety cover including a protrusion at a center, a disk holder including an opening at a center, a stripper disk including a cavity at a center, and a sub disk that joins to the protrusion extending through the opening of the disk holder and the cavity of the stripper disk are combined in this order from relatively on an outer side to an inner side of the housing member, and
the stripper disk includes a recess on a surface on the relatively inner side of the housing member, and the recess houses the sub disk.

<2>

The secondary battery according to <1>, wherein a terminal electrically connected to the battery element is in contact with a second surface facing a first surface of the sub disk joined to the protrusion, and an outer lower surface of the recess of the stripper disk.

<3>

The secondary battery according to <2>, wherein the second surface of the sub disk and the outer lower surface of the recess of the stripper disk are flush with each other.

<4>

The secondary battery according to any one of <1> to <3>, wherein the stripper disk has a thickness of 0.35 to 0.40 mm.

<5>

The secondary battery according to any one of <1> to <4>, wherein a material constituting the stripper disk has a tensile strength of 230 to 290 N/mm² obtained by a tensile test in accordance with JIS Z2241.

<6>

The secondary battery according to <5>, wherein the material is aluminum or an aluminum alloy.

<7>

The secondary battery according to any one of <1> to <6>, wherein
the stripper disk includes:
   a plurality of cavities disposed radially from a center of the stripper disk in plan view; and
   a plurality of protrusions disposed on an outer edge side of the cavities in a radial direction from the center, and
the number of the plurality of cavities and the number of the plurality of protrusions are the same, and each of the plurality of protrusions face corresponding one of the plurality of cavities in the radial direction orthogonal to a battery axis.

<8>

The secondary battery according to any one of <1> to <7>, wherein the sub disk has a diameter smaller than a recess diameter of the recess.

<9>

The secondary battery according to any one of <1> to <8>, wherein the recess of the stripper disk has an inner diameter that increases toward a relatively inner side of a battery axis.

<10>

The secondary battery according to any one of <1> to <9>, wherein a member constituting the disk holder includes a resin member.

### EXAMPLES

Hereinafter, the present disclosure will be described in further detail including with reference to Examples according to an embodiment. The present disclosure is not limited thereto.

### Example 1

### [1. Production of Test Battery]

Prepared was a secondary battery having the following specifications. The configuration of Example 1 is summarized in Table 1.
Shape: tubular shape (diameter: about 22 cm, axial length: about 70 mm)
Positive electrode and negative electrode of electrode assembly: positive electrode and negative electrode capable of occluding and releasing lithium ion
Nominal capacity: about 4100 mAh
Nominal voltage: 3.6 V
Safety valve: formed of safety cover, disk holder, stripper disk, and sub disk

### (Material of Each Member)

Safety cover: made of metal (metal containing aluminum)
Disk holder: made of thermoplastic resin (polypropylene (PP))
Exterior body and sub disk: made of metal (metal containing aluminum)

TABLE 1

| | Structure | | | | |
|---|---|---|---|---|---|
| | Stripper | Sub | | | Evaluation |
| | disk | disk | Stripper disk | | Vibration |
| | Recess on | Housed | | Tensile | test |
| | second | in | Thickness | strength | Acceptance |
| | surface | recess | (mm) | (N/mm²) | rate (%) |
| Example 1 | Present | Housed | 0.40 | 260 | 95 (A) |
| Example 2 | Present | Housed | 0.35 | 260 | 90 (A) |
| Example 3 | Present | Housed | 0.45 | 260 | 97 (A) |
| Example 4 | Present | Housed | 0.32 | 260 | 85 (A) |
| Example 5 | Present | Housed | 0.50 | 260 | 99 (A) |
| Example 6 | Present | Housed | 0.40 | 230 | 92 (A) |
| Example 7 | Present | Housed | 0.40 | 290 | 95 (A) |
| Example 8 | Present | Housed | 0.40 | 220 | 88 (A) |
| Example 9 | Present | Housed | 0.40 | 300 | 97 (A) |
| Comparative | Absent | Not | 0.40 | 260 | 80 (B) |
| Example 1 | (flat) | housed | | | |
| Comparative | Absent | Not | 0.31 | 260 | 75 (B) |
| Example 2 | (flat) | housed | | | |

### [2. Measurement Method]

### (2-1. Method for Measuring Tensile Strength)

The tensile strength of the material constituting the stripper disk was measured by a tensile test in accordance with Japanese Industrial Standard (JIS) Z2241.

### [3. Evaluation Method]

### (3-1. Evaluation of Vibration Resistance: Vibration Test)

A vibration test was performed under normal temperature and normal pressure (23±2° C., 1 atm) in accordance with the UN38.3 standard.

The battery of Example 1 was fully discharged. Specifically, the battery was discharged to a constant voltage of 2.5 V at a temperature of 23±2° C. and a constant current of 4.0 A.

The electric resistance value (AC resistance value) of the discharged secondary battery was measured using a battery tester (the number of measurements n=100). Specifically, an AC constant current having a measurement frequency of 1 kHz was applied, and the voltage value was measured. The internal resistance value of the battery was calculated from the obtained voltage value. The average value of a plurality of internal resistance values was calculated, and the obtained average value was defined as “Electric resistance value before applying vibration”.

Sweep type vibration was applied to the discharged secondary battery. Specifically, the sweep was applied at a frequency of 7 Hz (minimum value), 200 Hz (maximum value), and 7 Hz (minimum value) over 15 minutes. With the frequency change as one cycle, the cycle was performed 12 times for each of the three directions: XYZ axes (XYZ axes shown in FIG. 1). The amplitude was 0.8 (mm). For the battery applied with the vibrations, the electric resistance value was measured (number of measurements n=100). The average value of a plurality of electric resistance values was calculated, and the obtained average value was defined as “Electric resistance value after applying vibration”.

From the obtained electric resistance values before and after applying vibration, the increase rate of electric resistance value due to applied vibration was calculated using the equation represented by (1):

$$Increase rate of electric resistance ( \% ) = [ ( Electric resistance value after applying vibration - Electric resistance value before applying vibration ) \text{} / Electric resistance value before applying vibration ] \times 100 \qquad ( 1 )$$

Based on the increase rate of electric resistance value, the vibration resistance of the secondary battery of Example 1 was evaluated according to the following evaluation criteria. The evaluation results of the vibration resistance are summarized in Table 1.

### [Evaluation Criteria]

A (Pass: Good): the increase rate of electric resistance value is less than 10%
B (Fail: Bad): the increase rate of electric resistance value is 10% or more
* The increase in the electric resistance value is caused by weakening or partial breakage of the joint portion between the safety cover 110 and the sub disk 140.

### Examples 2 to 9 and Comparative Examples 1 to 2

### [1. Production of Test Battery]

Test secondary batteries were produced in the same manner as in Example 1 except that the battery configuration was changed to the configuration shown in Table 1. As a specific change, in Comparative Examples 1 to 2, the second surface of the stripper disk was not provided with a recess, and the sub disk was not housed in the recess. In Examples 2 to 5 and Comparative Example 1, the thickness of the stripper disk was changed. In Examples 6 to 9, the tensile strength of the stripper disk was changed.

### [2. Measurement Method] and [3. Evaluation Method]

For the batteries of Examples 2 to 9 and Comparative Examples 1 to 2, the vibration test was performed in the same manner as in Example 1. Table 1 shows the evaluation results.

### Results: Examples 1 to 9 and Comparative Examples 1 to 2

In the secondary battery of Examples 1 to 9, as shown in Table 1, a recess was provided on the second surface of the stripper disk, and the stripper disk was housed in the recess. For the vibration test for the secondary batteries of Examples 1 to 9, all the results were A (Pass).

On the other hand, in the secondary battery of Comparative Examples 1 to 2, as shown in Table 1, no recess was provided on the second surface of the stripper disk, and the stripper disk was not housed in the recess. For the vibration test for the secondary batteries of Comparative Examples 1 to 2, all the results were B (Fail).

From the above, it is apparent that the secondary batteries of Examples 1 to 9, which are included in the scope of the invention of claim 1, have further improved vibration resistance as compared with Comparative Examples 1 to 2, which are out of the scope of the invention of claim 1.

The effects and the like of the above Examples are merely an example. Therefore, the present disclosure is not limited to the above matters, and may have additional effects.

The secondary battery according to the present disclosure can be typically used for applications in which use of electric energy is required. For example, the secondary battery according to the present disclosure can be used in various fields in which electric storage is assumed. Although it is merely an example, the secondary battery according to the present disclosure can be used in the fields of electricity, information, and communication in which electric and electronic equipment and the like are used (for example, electric and electronic equipment fields or mobile equipment fields including mobile phones, smartphones, notebook computers and digital cameras, activity meters, arm computers, electronic papers, and wearable devices, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (for example, the fields of hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery element;
a housing member that houses the battery element; and
a safety valve attached to the housing member,
wherein the safety valve includes at least a configuration in which a safety cover including a protrusion at a center, a disk holder including an opening at a center, a stripper disk including a cavity at a center, and a sub disk that joins to the protrusion extending through the opening of the disk holder and the cavity of the stripper disk are combined in this order from relatively on an outer side to an inner side of the housing member, and
the stripper disk includes a recess on a surface located on the relatively inner side of the housing member, and the recess houses the sub disk.

2. The secondary battery according to claim 1, wherein a terminal electrically connected to the battery element is in contact with a second surface facing a first surface of the sub disk joined to the protrusion, and an outer lower surface of the recess of the stripper disk.

3. The secondary battery according to claim 2, wherein the second surface of the sub disk and the outer lower surface of the recess of the stripper disk are flush with each other.

4. The secondary battery according to claim 1, wherein the stripper disk has a thickness of 0.35 to 0.40 mm.

5. The secondary battery according to claim 1, wherein a material constituting the stripper disk has a tensile strength of 230 to 290 N/mm² obtained by a tensile test in accordance with JIS Z2241.

6. The secondary battery according to claim 5, wherein the material is aluminum or an aluminum alloy.

7. The secondary battery according to claim 1, wherein the stripper disk includes:
a plurality of cavities disposed radially from a center point of the stripper disk in plan view; and
a plurality of protrusions disposed on an outer edge side of the cavities in a radial direction from the center point, and
the number of the plurality of cavities and the number of the plurality of protrusions are the same, and each of the plurality of protrusions face corresponding one of the plurality of cavities in the radial direction orthogonal to a battery axis.

8. The secondary battery according to claim 1, wherein the sub disk has a diameter larger than an opening diameter of the cavity and smaller than a recess diameter of the recess.

9. The secondary battery according to claim 1, wherein the recess of the stripper disk has an inner diameter that increases toward a relatively inner side of a battery axis.

10. The secondary battery according to claim 1, wherein a member constituting the disk holder includes a resin member.
